(19) United States
(12) Patent Application Publication
(10) Pub. No.: US 2023/0013806 A1
(43) Pub. Date: Jan. 19, 2023

(54) LOCKS FOR DOORS

(71) Applicant: Consumer 2.0 Inc., Los Angeles, CA (US)

(72) Inventors: Zhong LIANG, Shenzhen (CN); Xuefeng GU, Shenzhen (CN)

(21) Appl. No.: 17/447,202

(22) Filed: Sep. 9, 2021

(30) Foreign Application Priority Data
Jul. 7, 2021 (CN) 202110764941.2
Jul. 7, 2021 (CN) 202121544374.1

(51) Int. Cl. E05B 9/00

(52) U.S. Cl. CPC E05B 9/002; E06B 5/16

(57) ABSTRACT

In an embodiment, the present application provides a lock for a door. The door has a front side and an opposing, back side which define a lock installation hole therethrough. The lock comprises: a front panel assembly, disposed on the front side; a rear panel assembly, disposed on the back side; a lock body, disposed within the lock installation hole; and at least one connector. The front panel assembly and the rear panel assembly are fixedly connected to the front side and back side, respectively, by the at least one connector, at least a portion of the front panel assembly and/or at least a portion of the rear panel assembly comprises a high-temperature resistant material, and when in an installed state, the at least a portion of the front panel assembly and/or the at least a portion of the rear panel assembly is configured to cover the lock installation hole. The lock provided by the present application has fireproof capability and is simple and convenient to install.

### CROSS-REFERENCE TO RELATED APPLICATION

This application claims priorities to, and the benefits of, Chinese Invention Patent Application No. filed on 202110764941.2 filed on 7 Jul. 2021 and Chinese Utility Model Patent Application No. 202121544374.1 filed on 7 Jul. 2021. The entire content of the foregoing applications is hereby incorporated by reference herein in its entirety.

### FIELD OF INVENTION

The present disclosure relates to the fields of locks, and in particular to locks for doors.

### BACKGROUND OF INVENTION

The existing door locks mainly use entire zinc alloy or aluminum alloy structures for front lock assemblies in their designs. When a fire disaster occurs, the zinc alloy or aluminum alloy structures of the front lock assemblies is heated and melted due to high temperatures. In such case, front and rear fixing screws would fall freely from a lock installation through-hole in a door, a rear cover plate then would fall off from the door, external fire sources and smoke would spread into a room from a lock seam, thereby causing personal and property damages and greatly reducing the safety and practicability of the door locks.

### SUMMARY OF INVENTION

In some embodiments, the present application aims to solve the problems in the prior art whereby after a fire disaster occurs, external fire sources and smoke would spread into a room from a lock seam.

In one aspect, the present application provides a lock for a door, the door having a front side and an opposing, back side and defining a lock installation hole therethrough, the lock comprising: a front panel assembly, disposed on the front side; a rear panel assembly, disposed on the back side; a lock body, disposed within the lock installation hole; and at least one connector, wherein the front panel assembly and the rear panel assembly are fixedly connected to the front side and back side, respectively, by the at least one connector, at least a portion of the front panel assembly and/or at least a portion of the rear panel assembly comprises a high-temperature resistant material, and when in an installed state, the at least a portion of the front panel assembly and/or the at least a portion of the rear panel assembly is configured to cover the lock installation hole.

In another aspect, the present application provides a lock for a door, the door having a front side and an opposing, back side and defining a lock installation hole therethrough, the lock comprising: a front panel assembly, comprising a front panel that is disposed on and fixed to the front side; a rear panel assembly, comprising a rear panel that is disposed on and fixed to the back side; a lock body, disposed within the lock installation hole; and a cover plate assembly, comprising a front cover plate and a rear cover plate, wherein the front cover plate is fixedly connected to the front panel, the rear cover plate is disposed between the back side and the rear panel assembly, and the front cover plate and/or the rear cover plate comprises a high-temperature resistant material and is configured to cover the lock installation hole.

In a further aspect, the present application provides a lock for a door, the door having a front side and an opposing, back side and defining a lock installation hole therethrough, the lock comprising: a front panel assembly, comprising: a front panel fixed to the front side, and a front cover plate comprising a high-temperature resistant material and fixedly connected to the front panel; a rear panel assembly, comprising: a rear panel fixed to the back side, and a rear cover plate comprising a high-temperature resistant material and fixedly connected between the back side and the rear panel; and a lock body disposed within the lock installation hole, and further comprising: a knob for opening the lock from the back side, and a connecting shaft comprising a front end and a rear end, wherein the front end thereof is fixedly connected to the lock body, and the rear end thereof is connected to the knob; when in an installed state, the front cover plate and/or the rear cover plate covers the lock installation hole, and the front cover plate and the rear cover plate each comprise at least one threaded hole configured to fit with each other for connecting the front cover plate to the front side and the rear cover plate to the back side respectively by means of a screw; and the rear cover plate further comprises a protrusion portion for inserting into the lock installation hole to position an installation position of the rear cover plate.

The present application has many advantages in various embodiments. In some embodiments, according to the lock for the door provided by the present application, the materials capable of resisting high-temperature in a fire scene are disposed in the front panel assembly and the rear panel assembly of the lock, and at least the high-temperature resistant material is firmly fixed to one side or two sides of the lock installation hole in a special fixed manner. The high-temperature resistant material can still substantially cover all or most of the lock installation hole even if the rest of the lock are melted due to the high temperature, to prevent a fire from spreading and smoke from diffusing into a room from a lock seam, thereby greatly improving the safety. In some embodiments, the whole lock has a very simple overall structure, is quick and easy to install, and has outstanding advantages.

### BRIEF DESCRIPTION OF FIGURES

The features and advantages of the present application may be further understood with reference to the remaining parts of the specification and the drawings. The same components in the drawings are indicated with the same reference numerals. In some cases, a sub sign is placed after a reference numeral and hyphen to represent one of many similar components. When a reference number is mentioned but not specifically stated an existing sub sign, it refers to all similar components.

FIG. 1 is an exploded view of the structure of a lock according to one of the embodiments of the present application.

FIG. 2 is a schematic view of the partial assembling of the exploded view of the embodiment of FIG. 1.

FIG. 3 shows a state of a lock of one of the embodiments of the present application in a fire environment.

FIG. 4 shows another state of the lock of one of the embodiments of the present application in the fire environment.

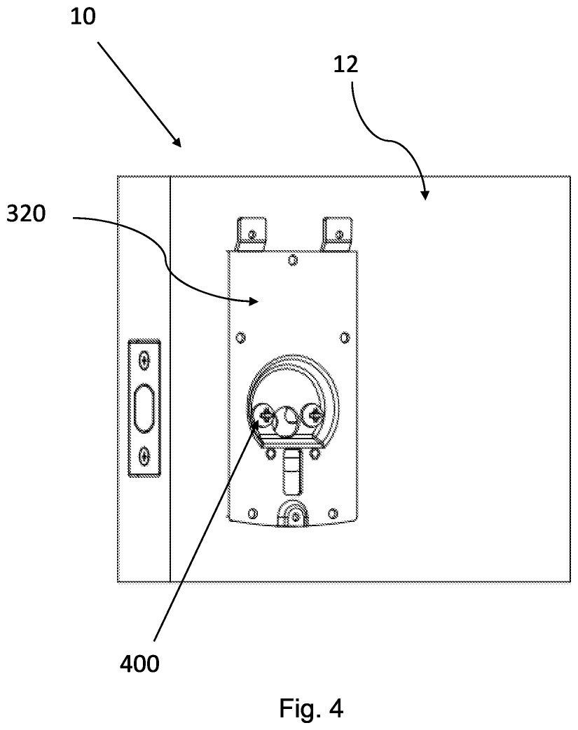

| | | | |
|---|---|---|---|
| 100 | Lock | 200 | Front panel assembly |
| 300 | Rear panel assembly | 400 | Connector |
| 500 | Lock body | 210 | Front panel |
| 220 | Front cover plate | 230 | Screen |
| 320 | Rear cover plate | 310 | Rear panel |
| 2120 | Main body portion | 2221 | Front fixing hole |
| 2222 | Signal line hole | 2123 | Guiding portion |
| 2124 | Space | 2125 | Outer circumference |
| 3230 | Protrusion portion | 3231 | Rear fixing hole |
| 3132 | Knob | 3233 | Rear cover plate screw |
| 510 | Bolt | | |
| 10 | Door | 11 | Front side |
| 12 | Back side | 13 | Lock installation hole |

### DETAILED DESCRIPTION OF THE PREFERRED EMBODIMENTS

The embodiments are described in greater detail below with reference to the following embodiments, which are provided herein by way of illustration only and are not intended to be limiting.

The present application has many variations which can be expected by those skilled in the art, and the use effect of the present application can be achieved.

In the present application, the space or position defining terms, such as inner, outer, upper, lower, left, right, top, bottom, front side and back side, are defmed with reference to a placing position of a lock in an installed state.

In the present application, the term “comprising” means including, but not limited to, the following elements, that is, not excluding other elements.

In the present application, the term “front panel” refers to a support structure disposed correspondingly on a front side of a door and forming a main profile of the front side of the lock, which is not limited to a planar structure only. For example, the “front panel” may include a planar or non-planar portion.

In the present application, the term “rear panel” refers to a support structure disposed correspondingly on the back side of the door and forming a main profile of the back side of the lock, which is not limited to a planar structure only. For example, the “rear panel” may include a planar or non-planar portion.

In the present application, the term “covering” is not only limited to an absolute state in which smoke cannot pass through a lock installation hole at all, but also includes a relative state in which most of the lock installation hole is covered.

In the present application, the space or position defining terms, such as “inner”, “outer”, “upper”, “lower”, “left”, “right”, “top”, “bottom”, “front side” and “back side” are defmed with reference to the placing position of the door lock of the embodiment in the installed state. The terms are only used for describing reference points for the convenience of description and thus will not limit the exemplary embodiments to any particular orientation or configuration.

As used herein and in the claims, the term “connecting” refers to the direct or indirect physical combination of one element and another element.

As used herein and in the claims, the terms “generally”, “substantially”, “roughly”, “approximately”, and “about” mean that the recited feature, angle, shape, state, structure, or value need not be achieved exactly, but that deviations or variations, including for example, tolerances, measurement errors, measurement accuracy limitations and other factors known to those of skill in the art, may occur in amounts that do not preclude the effect the feature was intended to provide. For example, an object “generally” perpendicular to an axis, line, or surface means that the object is either completely perpendicular to the axis, line, or surface or nearly completely perpendicular to the axis, line, or surface, for example, having a deviation of 5%.

One aspect of the present application provides a lock for a door, the door having a front side and an opposing, back side and defining a lock installation hole therethrough, the lock comprising: a front panel assembly, disposed on the front side; a rear panel assembly, disposed on the back side; a lock body, disposed within the lock installation hole; and at least one connector, wherein the front panel assembly and the rear panel assembly are fixedly connected to the front side and back side, respectively, by the at least one connector, at least a portion of the front panel assembly and/or at least a portion of the rear panel assembly comprises a high-temperature resistant material, and when in an installed state, the at least a portion of the front panel assembly and/or the at least a portion of the rear panel assembly is configured to cover the lock installation hole. According to the embodiment, the lock has fireproof capability itself, and even if most of the materials of the lock are melted at a high temperature in a fire, a part of the high-temperature resistant material is left on one side or two sides of the lock installation hole in a unique connection manner, so that the lock installation hole maintains the ability to prevent smoke.

In an embodiment, at least a portion of the front panel assembly comprises a front cover plate which is made of a high-temperature resistant material and is sufficient to cover the lock installation hole; and/or at least a portion of the rear panel assembly comprises a rear cover plate which is made of a high-temperature resistant material and is sufficient to cover the lock installation hole.

In an embodiment, the front panel assembly further comprises a front panel. The front cover plate is disposed within and fixedly connected to the front panel.

In an embodiment, the rear panel assembly further comprises a rear panel. The rear cover plate is fixedly connected to the rear panel.

In some embodiments, the high-temperature resistant material of the rear cover plate is carbon steel.

In an embodiment, the front cover plate and the rear cover plate comprise at least one front fixing hole and at least one rear fixing hole that correspond to each other respectively and are configured to fit with each other for fixedly connecting the front cover plate and the rear cover by means of at least one connector, thereby covering the lock installation hole.

In an embodiment, the front fixing hole and the rear fixing hole are threaded holes, and the connector is a screw.

In an embodiment, the rear cover plate comprises a protrusion portion that is configured to fit with the lock installation hole and used for inserting into the lock installation hole to position an installation position of the rear cover plate.

In an embodiment, the front panel comprises a guiding portion that has an outer circumference matching at least a portion of a profile of the lock installation hole and is used for inserting into the lock installation hole to position an installation position of the front panel and/or limit a position of the lock body. Accurate positioning between relatively simple parts of the lock and between the parts and the door is achieved.

In an embodiment, the front panel further comprises a main body portion that is made of an alloy material with good ductility. The main body portion is fixedly connected to the front cover plate.

In an embodiment, the front panel assembly further comprises a screen that allows user interaction to control the lock, so that a user can complete unlocking by entering a command, such as a password and a fingerprint, from the screen.

In some embodiments, the lock body further comprises a connecting shaft, and a knob for opening the lock from the back side. The connecting shaft passes through the rear cover plate to connect the lock body and the knob.

Another aspect of the present application provides a lock for a door, the door having a front side and an opposing, back side and defining a lock installation hole therethrough, the lock comprising: a front panel assembly, comprising a front panel that is disposed on and fixed to the front side; a rear panel assembly, comprising a rear panel that is disposed on and fixed to the back side; a lock body, disposed within the lock installation hole; and a cover plate assembly, comprising a front cover plate and a rear cover plate, wherein the front cover plate is fixedly connected to the front panel, the rear cover plate is disposed between the back side and the rear panel assembly, and the front cover plate and/or the rear cover plate comprises a high-temperature resistant material and is configured to cover the lock installation hole.

In an embodiment, the front cover plate comprises at least one front fixing hole, the rear cover plate is provided with at least one rear fixing hole, and the front and rear fixing holes are configured to fit with each other for fixedly connecting the front cover plate to the front side and the rear cover plate to the back side by means of a connector.

In an embodiment, the front panel comprises a guiding portion that has an outer circumference adapted to at least a portion of a profile of the lock installation hole and is used for inserting into the lock installation hole to position an installation position of a front panel and/or limit a position of the lock body.

In an embodiment, the rear cover plate comprises a protrusion portion that is configured to fit with the lock installation hole and used for inserting into the lock installation hole to position an installation position of the rear cover plate.

A further aspect of the present application provides a lock for a door, the door having a front side and an opposing, back side and defining a lock installation hole therethrough, the lock comprising: a front panel assembly, comprising: a front panel fixed to the front side of the door, and a front cover plate comprising a high-temperature resistant material and fixedly connected to the front panel; a rear panel assembly, comprising: a rear panel fixed to the back side, and a rear cover plate comprising a high-temperature resistant material and fixedly connected between the back side of the door and the rear panel; and a lock body disposed within the lock installation hole, and further comprising: a knob for opening the lock from the back side, and a connecting shaft comprising a front end and a rear end, wherein the front end thereof is fixedly connected to the lock body, and the rear end thereof is connected to the knob; when in an installed state, the front cover plate and/or the rear cover plate covers the lock installation hole, and the front cover plate and the rear cover plate each comprise at least one threaded hole configured to fit with each other for connecting the front cover plate to the front side and the rear cover plate to the back side respectively by means of a screw; and the rear cover plate further comprises a protrusion portion for inserting into the lock installation hole to position an installation position of the rear cover plate.

In some embodiments, the high-temperature resistant material of the front cover plate and the rear cover plate is carbon steel.

The embodiments of the present application are described in further detail below with reference to the accompanying drawings.

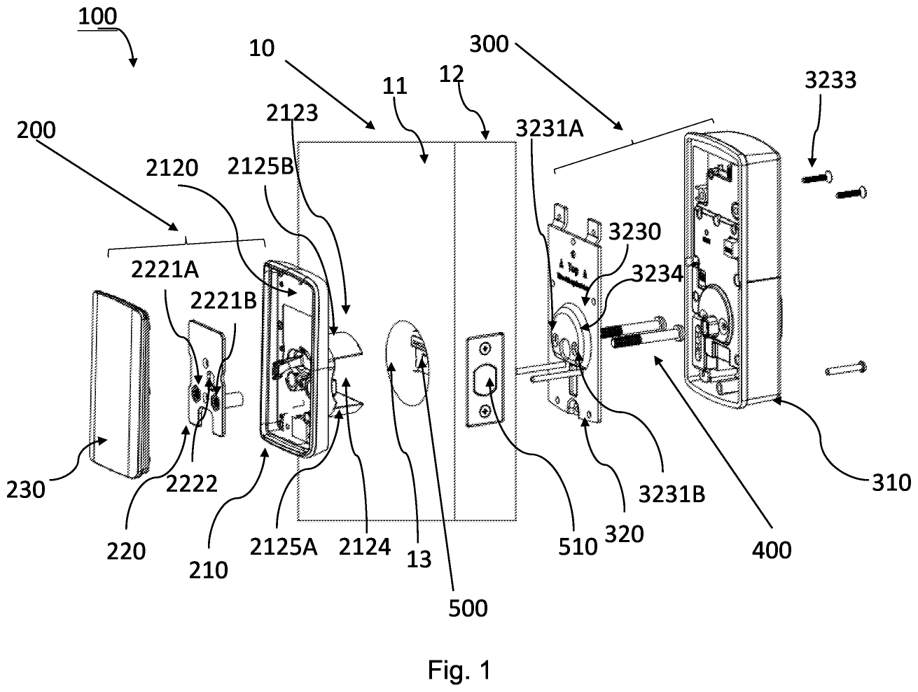

An exploded view of a lock 100 of an embodiment is as shown in FIG. 1, which is structurally disposed in a door 10. The door 10 has a front side 11 (for example, located outside a space separated by the door) and a back side 12 opposite to the front side 11 (for example, located inside the space separated by the door), and the door 10 is further provided with a lock installation hole 13 penetrating through the front side 11 and the back side 12 of the door 10. In the illustrated embodiment, the lock 100 generally includes a front panel assembly 200, a rear panel assembly 300, a lock body 500, and a connector 400. The front panel assembly 200 is disposed on the front side 11, and the rear panel assembly 300 is disposed on the back side 12. The connector 400 fixes the front panel assembly 200 and the rear panel assembly 300 to each other by means of the lock installation hole 13. The lock body 500 is disposed in the lock installation hole 10, and the lock body 500 is a main body that drives a bolt 510 to eject from or retract into the door 10. The bolt 510 locks the door when being ejected, and the bolt 510 opens the door when being retracted into the door. The structure and arrangement of the lock body 500 and the bolt 510 in the figures are merely illustrative and do not exclude other ways in the prior art. The lock body may include a lock body driven by an electric motor.

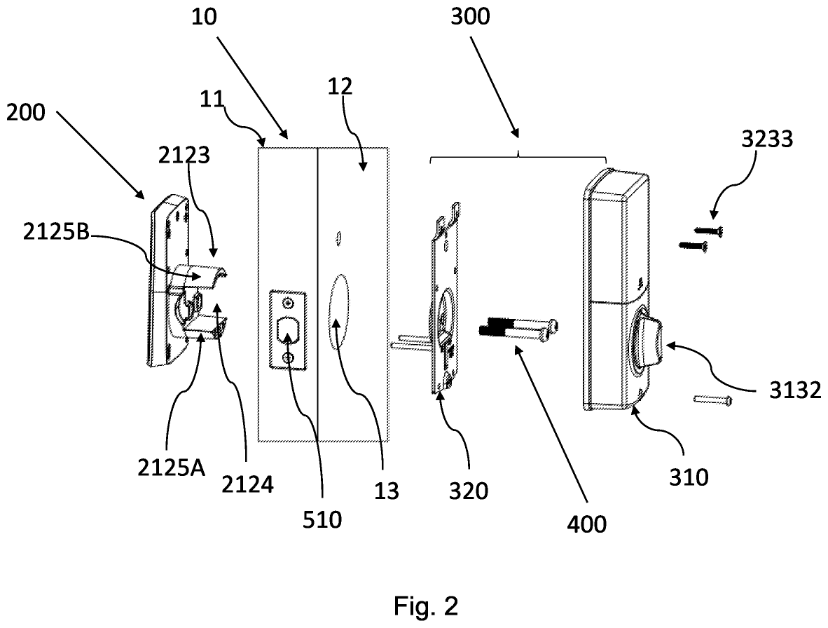

Referring to FIG. 2 in conjunction with FIG. 1, the front panel assembly 200 is disposed on the front side 11 of the door 10 and comprises a front panel 210, a front cover plate 220, and a screen 230. The front cover plate 220 is disposed within the front panel 210 and is fixedly connected to the front panel 210. The front panel 210 comprises an outer frame for forming an overall support frame structure of the front panel assembly 200, and a main body portion 2120. The overall profile of the outer frame is substantially a cuboid with rounded corners. The main body portion 2120 is made of a metal with good ductility. The metal with good ductility includes, but not limited to, a zinc alloy or an aluminum alloy. In an embodiment, the side of main body portion 2120 facing the front side 11 is provided with an outwardly-extending guiding portion 2123 for positioning a relative position of the front panel 210 to the lock installation hole 13 and a relative position of the lock body 500 within the lock installation hole 13. As shown in FIG. 1, the guiding portion 2123 has an outer circumference 2125 matching at least a portion of the inner diameter of the lock installation hole 13. The outer circumference 2125 comprises two portions, i.e. an upper and a lower portion 2125A, 2125B. Each portion has an arc-shaped surface having a diameter the same as or slightly smaller than that of the lock installation hole 13. The center of the outer circumference 2125 defines a space 2124 configured to match the lock body 500 such that the front panel 210 is fixed to the door 10 in place and cannot move after the guiding portion 2123 is inserted into the lock installation hole 13, and a portion or the entirety of the lock body 500 fits with the space 2124 such that the lock body 500 is in a relatively fixed position within the lock installation hole 13. The main body portion 2120 is further provided with a number of through holes serving as connecting holes for components such as the front cover plate and the rear cover plate, or as passages for components such as signal lines. The front cover plate 220 may be made of a high-temperature resistant material, such as carbon steel. The fixing methods for the front cover plate 220 and the front panel 210 include welding, snap-fit connection, screwing, and other connection methods, such that the front cover plate 220 and the front panel 210 can be an integral part in an assembled state. In an embodiment, the front cover plate 220 is sized to completely cover or substantially cover the lock installation hole 13. The front cover plate 220 may be provided with a number of through holes, such as two front fixing holes 2221A, 2221B shown in the figures. In this embodiment, the front fixing holes 2221A, 2221B may be threaded holes. In this embodiment, the front cover plate 220 may be provided with a signal line hole 2222 therethrough for enabling electrical signal connection with the screen 230. In an embodiment, the front cover plate 220 may also be provided with one or more additional connecting holes for fixing to other components. Optionally, the lock 100 further comprises the screen 230, which is fixedly connected to the front panel 210 and used for an interactive operation with a user, for example, for allowing the user to input an unlocking password or enter an unlocking fingerprint, or for collecting an unlocking video. After being assembled, the screen 230 may form an integral whole with the front panel 210 to form the front panel assembly 200 as shown in FIG. 2, facilitating installation and use of the front panel assembly 200 as one part by a user.

Still referring to FIGS. 1 and 2, the rear panel assembly 300 is disposed on the back side 12 of the door 10, and the rear panel assembly 300 comprises a rear panel 310 and a rear cover plate 320. The rear cover plate 320 is disposed between the back side 12 and the rear panel 310. In an embodiment, the rear panel 310 may be an integral assembly having other components disposed therein for cooperative movement with the lock body 500, and the rear panel 310 may be further provided with a knob 3132. The knob 3132 is connected to the lock body 500 via a connecting shaft (not shown). When being rotated, the knob 3132 can control the lock body 500 and push out or pull back the bolt 510, that is, the opening and closing of the lock body 500 can be controlled from the inside of the door. In some embodiments, the rear cover plate 320 may be made of a high-temperature resistant material, such as stainless steel and carbon steel. In this embodiment, the rear cover plate 320 is sized to completely cover the lock installation hole 13. In some embodiments, the rear cover plate 320 is sized to substantially cover the lock installation hole 13. In this embodiment, the rear cover plate 320 may be provided with a number of holes serving as fixing holes for fixing between different components by means of screws, bolts, etc., and the two rear fixing holes 3231A, 3231B shown in FIG. 1 are two of the number of holes in the rear cover plate and are sized and shaped such that the connectors 400 can pass therethrough. In this embodiment, the connectors 400 are two screws which, when being installed, can pass through the threaded holes of the front fixing holes 2221A, 2221B and the rear fixing holes 3231A, 3231B for threaded connection. In an embodiment, the connector 400 may be a screw made of a high-temperature resistant material. A threaded end of the connector 400 passes through the rear fixing hole 3231 in the rear cover plate 320, can pass through the rear fixing hole 3231A, 3231B, and is in threaded connection with the threaded hole of the front fixing hole 2221A, 2221B via the lock installation hole 13. In an embodiment, a protrusion portion 3230 may be further disposed on the rear cover plate 320. The protrusion portion 3230 has a flanged outer circumference 3234 that matches at least a portion of the lock installation hole 13 and is used for positioning the installation position of the rear cover plate 320 on the door 10. In an embodiment, the rear cover plate 320 is fixedly connected to the rear panel 310 by means of rear cover plate screws 3233 when being installed. In an embodiment, the rear cover plate 320 and the rear panel 310 may be fixed as an integral part in an assembled state.

In an embodiment, when installing the lock 100 onto the door 10, the user takes out the front panel assembly 200, inserts the guiding portion 2123 into the lock installation hole 13 from the front or the front side 11 of the door 10, then puts the lock body 500 into a space defined by the guiding portion 2123 and the lock body installation hole 13 from a side hole of the door 10, causes a signal line to pass through the signal line hole 2222 in the front panel assembly 200 to connect same to the screen 230, and then installs the rear panel assembly 300 as a whole into the lock installation hole 13 from the back side of the door, such that the threaded end of the connector 400 passes through the lock installation hole 13, is connected to the corresponding hole in the front panel assembly 200, and is screwed to achieve the fixed connection between the front panel assembly 200 and the rear panel assembly 300.

In some embodiments, when installing the lock onto the door, the user takes out the front panel assembly 200, and inserts a positioning portion 23 into the lock installation hole 13 from the front or the front side of the door 10. The lock body 500 is then put into a space defined by the positioning portion 23 and the lock body installation hole 13, and the signal line passes through the signal line hole in the front panel assembly and is connected to the screen 230. The rear cover plate 320 is then connected to the front panel assembly 200 by means of the connector 400 passing through the rear fixing hole 3231 therein. For example, the connector is connected to the front fixing hole 2221 in the front cover plate 220 and then screwed. Thereafter, the rear panel 310 and the rear cover plate 320 are fixedly connected by means of screws 3233. Accordingly, the front panel assembly 200 and the rear panel assembly 300 are fixedly connected to each other.

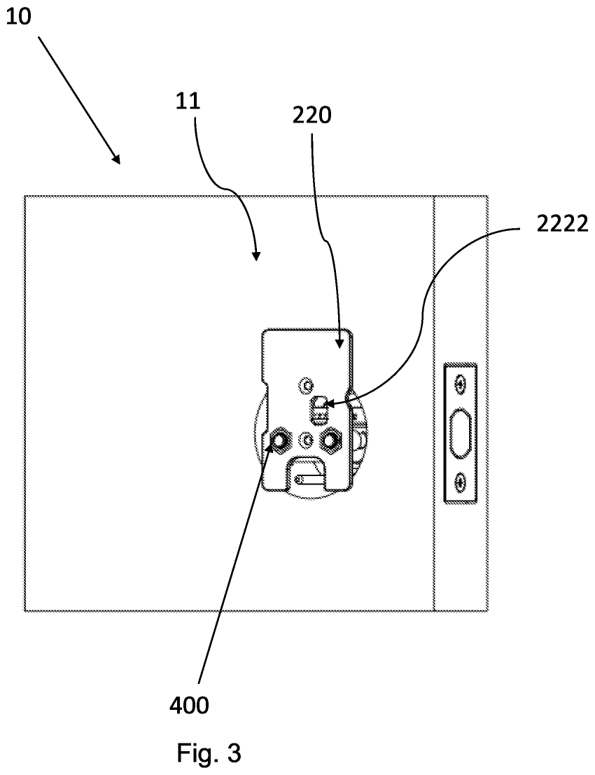

In a fire state, since the front panel assembly 200 and the rear panel assembly 300 are fixedly connected to each other, and at least one of the front panel assembly 200 and the rear panel assembly 300 completely covers the lock installation hole 13, smoke cannot pass through the lock installation hole 13 of the door 10. Even in the case where the screen 230 and the main body portion 2120 of the front panel 210 are burned to melt, since being made of or including a high-temperature resistant material, the front cover plate 220 and/or the rear cover plate 320 can resist the high temperature without melting, such that the front cover plate 220 forms a blocking state as shown in FIG. 3, and in further cooperation with the rear cover plate 320 on the back side 12, the whole lock installation hole 13 also blocks smoke from entering the opposite side of the door or the interior of a room through the lock installation hole 13, greatly improving the safety and the fireproof capability. Moreover, the whole lock has a very simple overall structure, is quick and easy to install, and has outstanding advantages.

The exemplary embodiments in this description provide methods by way of example only, and examples of one method are not intended to limit examples of another method. A device/method discussed in one figure may be added to or exchanged with devices/methods in the other figures. Furthermore, specific numerical data values (for example, specific numbers, quantities, categories, etc.) or other specific information are used merely to discuss the exemplary embodiments and are not intended to limit the exemplary embodiments with such specific information.

For example, the connectors described above fix the front panel assembly and the rear panel assembly to each other through the lock installation hole, but this may also be achieved by means of an additional separate through hole in the door. For example, the front panel assembly and the rear panel assembly are fixedly connected to each other by means of the screws and the threaded holes, but may be fixed in other ways, including welding, snap-fit connection, adhesive connection, etc.

For example, the structures and arrangements of the lock body and the bolt described above are shown in the examples, but the lock body and the bolt with a variety of specific different structures and activation ways may also be applied to the lock without excluding other structures and arrangements in the prior art.

What is claimed is:

1. A lock for a door, the door having a front side and an opposing, back side defming a lock installation hole therethrough, the lock comprising
(a) a front panel assembly, disposed on the front side;
(b) a rear panel assembly, disposed on the back side;
(c) a lock body, disposed within the lock installation hole; and
(d) at least one connector,
wherein the front panel assembly and the rear panel assembly are fixedly connected with the front side and back side, respectively, by the at least one connector, at least a portion of the front panel assembly and/or at least a portion of the rear panel assembly comprises a high-temperature resistant material, and when in an installed state, the at least a portion of the front panel assembly and/or the at least a portion of the rear panel assembly is configured to cover the lock installation hole.

2. The lock according to claim 1, wherein
the at least a portion of the front panel assembly comprises a front cover plate that is made of a high-temperature resistant material and is sufficient to cover the lock installation hole; and/or
the at least a portion of the rear panel assembly comprises a rear cover plate that is made of a high-temperature resistant material and is sufficient to cover the lock installation hole.

3. The lock according to claim 2, wherein the front panel assembly further comprises a front panel that is disposed within and fixedly connected with the front panel.

4. The lock according to claim 2, wherein the rear panel assembly further comprises a rear panel, and the rear cover plate is fixedly connected with the rear panel.

5. The lock according to claim 1, wherein the high-temperature resistant material is carbon steel.

6. The lock according to claim 2, wherein the high-temperature resistant material is carbon steel.

7. The lock according to claim 2, wherein
the front cover plate and the rear cover plate comprises at least one front fixing hole and at least one rear fixing hole that correspond to each other, respectively, configured to fit for fixedly connecting the front cover plate with the rear cover plate by the at least one connector, thereby cover the lock installation hole.

8. The lock according to claim 7, wherein
the front fixing hole and the rear fixing hole are threaded holes, and the connector is a screw.

9. The lock according to claim 2, wherein the rear cover plate comprises a protrusion portion configured to fit for the lock installation hole for inserting into the lock installation hole to position an installation position of the rear cover plate.

10. The lock according to claim 3, wherein the front panel further comprises a guiding portion that has an outer circumference matches with at least a portion of a profile of the lock installation hole for inserting into the lock installation hole to position an installation position of the front panel and/or limit a position of the lock body.

11. The lock according to claim 3, wherein the front panel further comprises a main body portion that is made of alloy material with good ductility, and the main body portion is fixedly connected with the front cover plate.

12. The lock according to claim 1, wherein the front panel assembly also comprises a screen that allows user interaction to control the lock.

13. The lock according to claim 2, wherein
the lock body further comprises
a connecting shaft; and
a knob for opening the lock at the back side,
the connecting shaft connects the lock body with the knob through the rear cover plate.

14. A lock for a door, the door having a front side and an opposing, back side defming a lock installation hole therethrough, the lock comprising
(a) a front panel assembly, comprising a front panel that is disposed on and fixed to the front side;
(b) a rear panel assembly, comprising a rear panel that is disposed on and fixed to the back side;
(c) a lock body disposed within the lock installation hole; and
(d) a cover plate assembly, comprising a front cover plate and a rear cover plate, the front cover plate is fixedly connected with the front panel, and the rear cover plate is disposed between the back side and the rear panel assembly,
wherein the front cover plate and/or the rear cover plate comprises a high-temperature resistant material and are configured to cover the lock installation hole.

15. The lock according to claim 14, wherein the front cover plate comprises at least one front fixing hole and the rear cover plate comprises at least one rear fixing hole configured to fit for fixedly connecting the front cover plate with the front side and the rear cover plate with the back side by a connector.

16. The lock according to claim 14, wherein the front panel comprises a guiding portion that has an outer circumference matches with at least a portion of a profile of the lock installation hole for inserting into the lock installation hole to position an installation position of the front panel and/or limit a position of the lock body.

17. The lock according to claim 14, wherein the rear cover plate comprises a protrusion portion configured to fit for the lock installation hole for inserting into to position an installation position of the rear cover plate.

18. A lock for a door, the door having a front side and an opposing, back side defming a lock installation hole therethrough, the lock comprising
(a) a front panel assembly, comprising:
a front panel, fixedly connected to the front side; and
a front cover plate, comprising a high-temperature resistant material, and fixedly connected with the front panel;
(b) a rear panel assembly, comprising:
a rear panel, fixedly connected with the back side; and
a rear cover plate, comprising a high-temperature resistant material, and fixedly connected between the back side and the rear panel; and
(c) a lock body, disposed within the lock installation hole, comprising:
a knob, for opening the lock from the back side; and
a connecting shaft, including a front end and a rear end, the front end is fixedly connected to the lock body, and the rear end is connected to the knob,
wherein in an installed state, the front cover plate and/or the rear cover plate covers the lock installation hole, the front cover plate and the rear cover plate each comprise at least one threaded hole configured to fit with each other for connecting the front cover plate to the front side and the rear cover plate to the back side respectively by means of a screw; the rear cover plate further comprises a protrusion portion for inserting into the lock installation hole to position an installation position of the rear cover plate.

19. The lock according to claim 18, wherein the high-temperature resistant material is carbon steel.
